(19) United States
(12) Patent Application Publication
(10) Pub. No.: US 2021/0071440 A1
(43) Pub. Date: Mar. 11, 2021

(54) LOCK SYSTEM AND METHOD FOR USING

(71) Applicant: Gate Labs Inc., San Francisco, CA (US)

(72) Inventors: Ehsan SAEEDI, San Francisco, CA (US); Harvey HO, San Francisco, CA (US)

(73) Assignee: Gate Labs Inc., San Francisco, CA (US)

(21) Appl. No.: 16/964,164

(22) PCT Filed: Jan. 10, 2019
(86) PCT No.: PCT/US2019/013004

§ 371 Date: Jul. 22, 2020

Related U.S. Application Data
(60) Provisional application No. 62/615,852, filed on Jan. 10, 2018.

(51) Int. Cl. E05B 9/08; E05B 47/00

(52) U.S. Cl. CPC E05B 9/08; E05B 2047/0058; E05B 47/0001

(57) ABSTRACT

A packaging fixture with a mounted locking device is disclosed. The packing fixture allows users to become familiar with the locking device and associated software applications while the locking device is still attached to the packaging fixture. The removal of the locking device from the packaging fixture demonstrates important aspects of the installation of the locking device on a door to help familiarize the user with the locking device and the installation procedure.

### CROSS-REFERENCE TO RELATED APPLICATIONS

This application claims priority to U.S. Provisional Application No. 62/615,852, filed Jan. 10, 2018 which is incorporated herein by reference in its entirety.

### BACKGROUND

Packaging fixtures and methods of using the same are disclosed. More specifically, packaging fixtures for set up, test, and evaluation of locking devices and methods of using the same are disclosed.

### BRIEF SUMMARY

This application discloses technology related to a locking device mounted to a packaging fixture (also referred to as a demo block). This technology allows users to set up, test, and evaluate the lock while it is still attached to the packaging fixture and before installation on a door. This technology also allows users to become familiar with an application associated with the lock while the lock is still attached to the packaging fixture and allows for searching out an optimal wireless signal location.

A packageable assembly for an electronic device is disclosed. The assembly can have an electronic locking device and a packaging fixture. The packageable assembly can have a first configuration and a second configuration. The electronic locking device can be assembled on the packaging fixture when the packageable assembly is in the first configuration. The electronic locking device can be detached from the packaging fixture when the packageable assembly is in the second configuration.

A locking device packaging fixture system for demonstrating a locking device is disclosed. The system can have a locking device packaging fixture can be configured to allow a user to operate a door management platform before the locking device is installed in a door. The door lock management platform can be configured to send, via a wireless communication interface, a real-time stream of video acquired by the camera to a computing device of an administrator of a door management platform.

A locking device packaging fixture system is disclosed that can have a locking device, a door management platform, and a packaging fixture that can have a packaging block. The packaging fixture can be of the same thickness as a standard outside door, and wherein the locking device can be removably attached to the packaging block.

A method for utilizing a locking device packaging fixture for testing a locking device is disclosed. The locking device packaging fixture can have a door management platform. The method can include providing a real-time video stream and/or two-way real-time audio connection between the door management platform and a computing device to enable a first user and a second user to be able to communicate. The method can include locking and/or unlocking the door management platform in response to a message from the computing device based on the real-time video stream and/or the two-way real-time audio connection.

A method for removing a locking device from a packaging fixture and installing the locking device on a door is disclosed. The method can include removing first alignment and connection elements of a deadbolt knob from second alignment and connection elements. The method can include removing a deadbolt knob from a back face of a packaging fixture. The method can include removing a lock front enclosure from a front face of the packaging fixture. The method can include removing a deadbolt from a lateral face of the packaging fixture. The method can include inserting a deadbolt into a cross-bore of the door. The method can include screwing a face plate to a lateral face of the door. The method can include sliding a deadbolt tailpiece through a tailpiece receiver. The method can include connecting the first alignment and connection elements of a deadbolt knob to second alignment and connection elements of a lock front enclosure.

### BRIEF DESCRIPTION OF THE DRAWINGS

The drawings shown and described are exemplary embodiments and non-limiting. Like reference numerals indicate identical or functionally equivalent features throughout.

FIG. 1 is a front perspective view of a package assembly having a variation of a locking device mounted to a variation of a packaging fixture.

FIG. 2 is a side view of the package assembly of FIG. 1.

FIG. 3 is a rear perspective view of the package assembly of FIG. 1.

FIG. 4a is a rear perspective view of the packaging fixture of FIG. 1.

FIG. 4b is a rear view of the packaging fixture of FIG. 1.

FIG. 5 is a front perspective view showing the lock back enclosure separated from package assembly of FIG. 1.

FIG. 6 is a rear perspective view showing the lock back enclosure separated from package assembly of FIG. 1.

FIG. 7 is a front perspective view showing the lock back enclosure and the deadbolt knob separated from package assembly of FIG. 1.

FIG. 8 is a rear perspective view showing the lock back enclosure and the deadbolt knob separated from package assembly of FIG. 1.

FIG. 9 shows internal components of the device 130 in a bore of the fixture of FIG. 1.

FIG. 10 is a front perspective view showing the lock back enclosure, the deadbolt knob, and the locking device first side separated from package assembly of FIG. 1.

FIG. 11 is a rear perspective view showing the lock back enclosure, the deadbolt knob, and the locking device first side separated from package assembly of FIG. 1 with the fixture 100 shown transparent for illustrative clarity.

FIG. 12 is front top perspective view showing the showing the lock back enclosure, the deadbolt knob, the locking device first side, and the deadbolt assembly separated from package assembly of FIG. 1.

FIG. 13 illustrates the package assembly of FIG. 2 in a box.

FIG. 14 is a rear perspective view showing the locking device completely removed from the packaging fixture and installed on a door.

FIG. 15 is a variation of a screen shot of a user interface.

FIG. 16 is a variation of a screen shot of a user interface.

FIG. 17A illustrates a variation of a tapered deadbolt.

FIG. 17B illustrates a variation of a tapered deadbolt.

FIG. 17C illustrates a variation of a tapered deadbolt.

FIG. 17D illustrates a variation of a tapered deadbolt.

FIG. 18A illustrates a variation of a multi-rod deadbolt in a fully locked configuration.

FIG. 18B illustrates the multi-rod deadbolt of FIG. 18A in a partially locked configuration.

FIG. 18C illustrates the multi-rod deadbolt of FIG. 18A in a partially locked configuration.

FIG. 18D illustrates the multi-rod deadbolt of FIG. 18A in a partially locked configuration.

FIG. 18E illustrates a variation of a multi-rod deadbolt in a door ajar configuration.

FIG. 18F illustrates a front view of a variation of a multi-rod deadbolt.

FIG. 18G illustrates a front view of a variation of a multi-rod deadbolt.

FIG. 18H illustrates a front view of a variation of a multi-rod deadbolt.

FIG. 18I illustrates a front view of a variation of a multi-rod deadbolt.

FIG. 18J illustrates a front view of a variation of a multi-rod deadbolt.

FIG. 18K illustrates a front view of a variation of a multi-rod deadbolt.

FIG. 18L illustrates a front view of a variation of a multi-rod deadbolt.

### DETAILED DESCRIPTION

This application discloses technology related to a package assembly for locks. The package assembly can include a locking device (also referred to as a lock) removably mounted to a packaging fixture (also referred to as a package fixture, packaging mount, lock mount, demo support, demo block, fixture, mount, support, and block). The package assembly can be disassembled by removing the lock from the packaging mount. This technology allows a user to become familiar with the lock and any associated software application while the lock is attached to the packaging fixture, for example, before the lock is removed from the fixture and installed on a door. This technology can be used during manufacturing when the device needs to be tested using connectors. The fixture can allow for connections to the interior of the device that would otherwise not be accessible during normal installation and operation. The ports would be on the interior. The user can gain experience with locking and unlocking the lock and other features including remote operation of the lock while the lock is attached to the packaging fixture. The user can also practice the removal and installation of the lock on the packaging fixture. The package assembly can be part of the product packaging of the lock in retail or commercial packaging. So that users can realize these benefits, users can purchase or receive the package assembly in an assembled state. For example, the package assembly can be in a package purchasable and/or deliverable to a user.

The locking device can have any of the features and functionality described in any of U.S. Provisional Application No. 62/564,852, filed Sep. 28, 2017; U.S. Provisional Application No. 62/578,295, filed Oct. 27, 2017; U.S. patent application Ser. No. 15/360,758, filed Nov. 23, 2016; U.S. patent application Ser. No. 14/736,126, filed Jun. 10, 2015; U.S. patent application Ser. No. 14/736,072, filed Jun. 10, 2015; U.S. patent application Ser. No. 14/641,069, filed Mar. 6, 2015; and U.S. patent application Ser. No. 14/641,047, filed Mar. 6, 2015; each of which is incorporated herein by reference in its entirety for all purposes.

Demo System

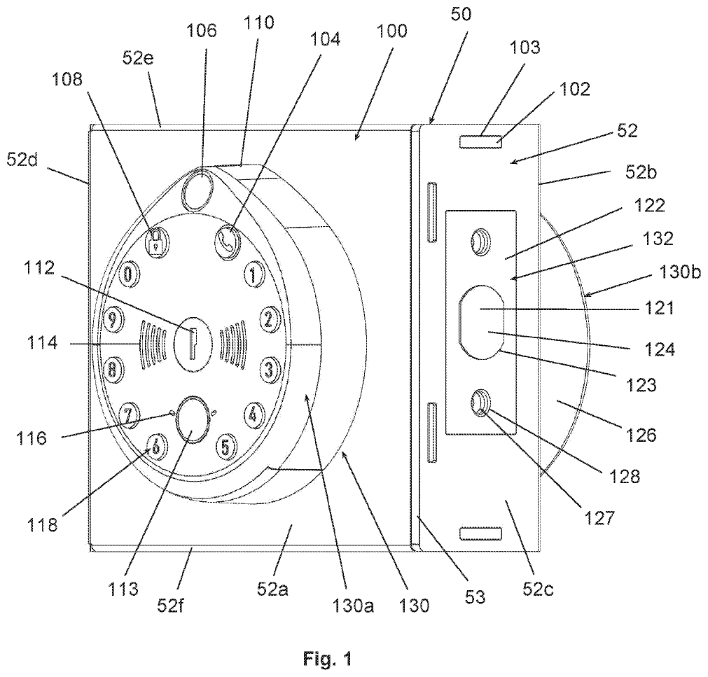

FIG. 1 illustrates a variation of a package assembly 50 having a locking device 130 removably attached to a packaging fixture 100. The locking device 130 can have a device first side 130a, a device second side 130b, and a deadbolt assembly 132. The device first side 130a can include a lock front enclosure 110, a camera 106, a lock button 108, a keyway 112, a speaker grill 114, a microphone 116, numerical keys 118, an infrared (IR) motion sensor 113, or any combination thereof. The device second side 130b can include a lock back enclosure 126 and/or a deadbolt knob (not shown). The lock back enclosure 126 can be a back cover and/or a removable battery pack. The deadbolt assembly 132 can include a deadbolt 121 having a deadbolt distal end 124. The deadbolt assembly 132 can include a deadbolt faceplate 122 having a deadbolt opening 123 and one or more attachment holes 128.

The device first side 130a can be removably attached to the device second side 130b, the deadbolt assembly 132, the fixture 100, a door, or any combination thereof. The device second side 130b can be removably attached to the device first side 130a, the deadbolt assembly 132, the fixture 100, a door, or any combination thereof. The deadbolt assembly 132 can be removably attached to the device first side 130a, the device second side 130b, the fixture 100, a door, or any combination thereof.

For example, FIG. 1 illustrates that the device first side 130a can be removably attached to the device second side 130b, the deadbolt assembly 132, and/or the fixture 100 when the package assembly 50 is in a fully assembled configuration. FIG. 1 further illustrates that the device second side 130b can be removably attached to the device first side 130a, the deadbolt assembly 132, and/or the fixture 100 when the package assembly 50 is in a fully assembled configuration. FIG. 1 further illustrates that the deadbolt assembly 132 can be removably attached to the device first side 130a, the device second side 130b, and/or the fixture 100 when the package assembly 50 is in a fully assembled configuration. The device first side 130a, the device second side 130b, and the deadbolt assembly 132 can be detached from one another and/or from the fixture 100 and then installed on a door.

The fixture 100 can have a regular or irregular geometric shape. The fixture 100 can have one or multiple exterior surfaces 52 (e.g., 1 to 10 or more exterior surfaces). The exterior surfaces 52 can be exterior surfaces of the fixture 100. Each exterior surface 52 can be planar and/or curved. For example, the fixture 100 can have a spherical shape, an ellipsoid shape, a polyhedral shape (e.g., square cuboid, rectangular cuboid, parallelepiped, block shape), a frustum shape (e.g., conical frustum, pyramidal frustum, polygonal frustum), a cylindrical shape, or any combination thereof. For a block-shaped fixture 100, there can be six exterior surfaces. For a cylindrical-shaped fixture 100, there can be three exterior surfaces. The fixture 100 can have one or multiple openings for access to the internal mechanisms of the lock. These openings can be sized and shaped in various forms to allow users to observe and test internal functions of the system. During manufacturing operations, these openings can allow for a cable to be attached to ports that are for test-only functionality.

For example, FIG. 1 illustrates that the fixture 100 can be block-shaped or nearly block-shaped having exterior first, second, third, fourth, fifth, and sixth surfaces 52a, 52b, 52c, 52d, 52e, and 52f, respectively. The exterior first and second surfaces 52a, 52b can be opposite from one another and perpendicular to the exterior third, fourth, fifth and sixth surfaces 52c, 52d, 52e, 52f. The exterior third and fourth surfaces 52c, 52d can be opposite from one another and perpendicular to the exterior first, second, fifth and sixth surfaces 52a, 52b, 52e, 52f. The exterior fifth and sixth surfaces 52e, 52f can be opposite from one another and perpendicular to the exterior first, second, third and fourth surfaces 52a, 52b, 52c, 52d. The exterior surfaces 52a-52f can each define a planar exterior surface. The exterior surfaces 52a-52f can be attached to or integrated with one another.

FIG. 1 further illustrates that a portion of the exterior surfaces (e.g., exterior surfaces of the fixture) can be covered by the locking device 130 when the package assembly 50 is in an assembled configuration.

FIG. 1 further illustrates that the deadbolt faceplate 122 can be attached to the fixture 100 (e.g., to the exterior third surface 52c) with one or more fasteners 129 (e.g., screws). The fasteners 129 can be inserted through the faceplate attachment holes 128.

FIG. 1 further illustrates that the deadbolt distal end 124 can be coplanar with an exterior surface of the fixture 100 (e.g., the exterior third surface 50c) when the deadbolt 121 is in an unlocked position.

The fixture 100 can be made of plastic, wood, metal, or other natural or man-made materials. The fixture 100 can be made from a single piece of material and machined or cut to size. The fixture 100 can be 3-D printed. The fixture 100 can be assembled from one or multiple pieces. The pieces can have tabs 102 and/or tab openings 103 which can allow the pieces to fit together easily or allow for a single piece to be folded together. Each tab 103 can be configured to fit into a tab opening 103. Each tab 102 can be an alignment tab that aligns an exterior surface with another exterior surface. Each opening 103 can be a through hole or a recess. FIG. 1 illustrates that the fixture 100 can be manufactured as a foldable template (e.g., a box template, a block template) having tabs and tab openings 102, 103. The tabs and tab openings 102, 103 can provide a precise fit. The tabs and tab openings 102, 103 can be magnetic or have a magnet. The tabs and tab openings 102, 103 can allow the one or multiple pieces of the fixture 100 to fit together with or without glue or other sealing compounds with a magnetic fit, snap fit, friction fit, loose fit, or any combination thereof.

FIG. 1 further illustrates that the device can have edges 53. The edges 53 can be rounded corners. The edges 53 can be angled corners, for example, square corners.

A rear surface of the lock front enclosure 110 can be in contact and flush with the front surface of the fixture 100 (e.g., the exterior first surface 52a) when the package assembly 50 is in an assembled configuration. A front surface of the lock back enclosure 126 and/or a front surface of a deadbolt knob (not shown) can be in contact and flush with the back surface of the fixture 100 (e.g., the exterior second surface 52b) when the package assembly 50 is in an assembled configuration. An assembled configuration can be a partially assembled configuration or a fully assembled configuration.

The locking device 130 can be an electronic device. The locking device 130 can be a non-electronic mechanical device. The fixture 100 can work with an electronic locking device 130 or a non-electronic mechanical locking device 130.

One or more surfaces (e.g., exterior surfaces and/or interior surfaces) of the fixture 100 can have printed text and/or printed images. The text can be braille. The text can include a model number, serial number, warnings, operating instructions, or any combination thereof. The printed images can include warnings and/or operating instructions. The operating instructions can include steps to remove the locking device 130 from the fixture 100. The operating instructions can include steps to attach the locking device 130 to a door. The operating instructions can be do-it-yourself (DIY) instructions.

The fixture 100 can include an embedded speaker and audio player circuitry. The embedded speaker and audio player circuitry can play audio operating instructions. Additionally or alternatively, the locking device 130 can play the audio operating instructions via a speaker of the device 130, for example, through the speaker grill 114. The audio operating instructions can include steps to remove the locking device 130 from the fixture 100. The audio operating instructions can include steps to attach the locking device 130 to a door. The audio operating instructions can automatically play when a switch is activated. For example, the switch can be a pressure switch that can be activated when the package assembly 50 is removed from the product packaging. Additionally or alternatively, the package assembly 50 can have one or multiple sensors that can detect when the locking device 130 is partially or fully removed from the fixture 100. Disassembly steps can be sequentially played as the one or more sensors detect the locking device 130 being disassembled from the fixture 100. Door attachment instructions can automatically play when the locking device 130 is partially or fully removed from the fixture 100. Additionally or alternatively, a computer (e.g., a smartphone) can be configured to play an installation video. Additionally or alternatively, the product packaging can include a user manual with disassembly and installation instructions.

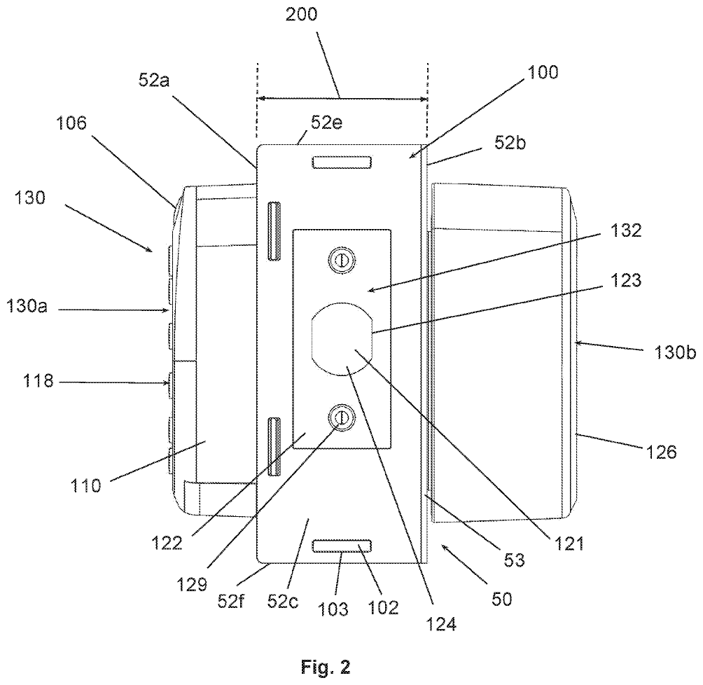

FIG. 2 illustrates that the fixture 100 can have a first dimension 200. The first dimension 200 can be the distance between the exterior first and second surfaces 52a, 52b. The first dimension 200 can correspond to a thickness (also referred to as a width) of the fixture 100. The first dimension 200 can range from about 25 mm to about 100 mm or more, including every 1 mm increment within this range. The first dimension 200 can range from about 1.000 inches to about 4.000 inches or more, including every 0.005 inch increment within this range. The first dimension 200 can be the same as or similar to common door thicknesses. For example, in the United Kingdom common door thicknesses are 35 millimeters, 40 millimeters, and 44 millimeters. The first dimension 200 can be about 35 millimeters, 40 millimeters, or 44 millimeters. In the US, common door thicknesses are 1.375 inches, 1.500 inches, 1.625 inches, and 1.750 inches. The first dimension 200 can be about 1.375 inches, 1.500 inches, 1.625 inches, and 1.750 inches.

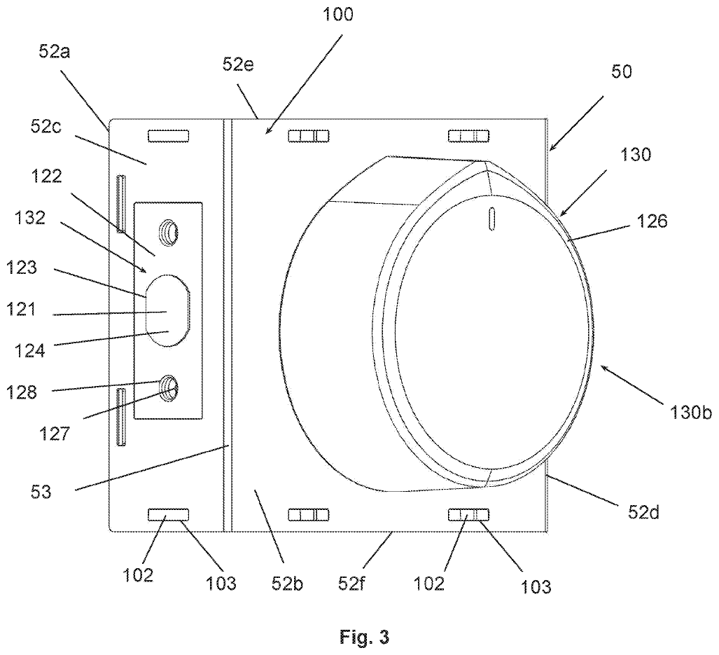

FIG. 3 illustrates that the alignment tabs 102 can fit into the tab openings 103 of the exterior second surface 52b.

FIG. 3 further illustrates that the fixture 100 can have one or multiple fastener channels 127 (e.g., 1, 2, 3, 4 or more fastener channels) configured to receive one or more corresponding fasteners 129 (e.g., screws). For example, FIG. 3 illustrates that the exterior third side 50c can have two fastener channels 127.

The fasteners 129 can be inserted through the one or more attachment holes 128 (e.g., door mounting screw holes), for example, along a mid-line symmetrically at the top and bottom of the face plate 122. The fasteners 129 can be inserted through the attachment holes 128 and into corresponding fixture mounting channels 127 aligned with the holes 128 to fix the faceplate 122 to the fixture 100.

FIG. 3 further illustrates the fasteners 129 detached from the package assembly 50, exposing the fastener channels 127 and attachment holes 128.

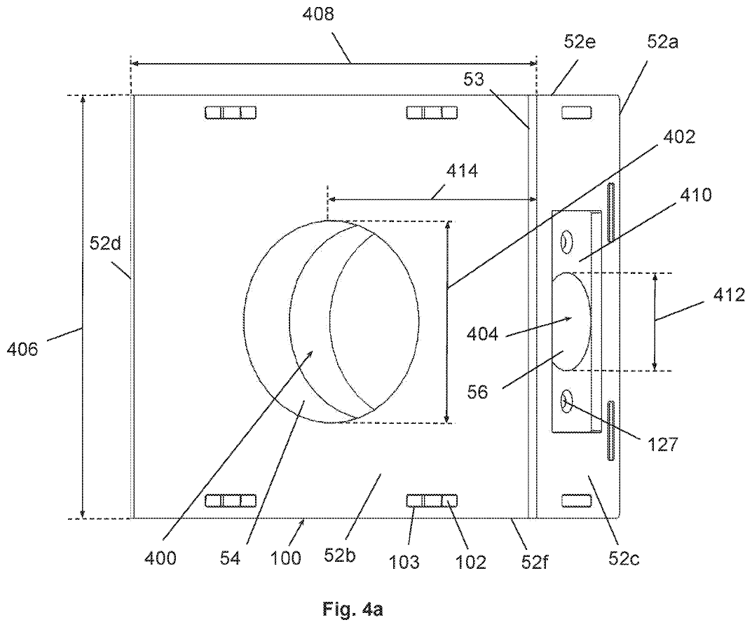

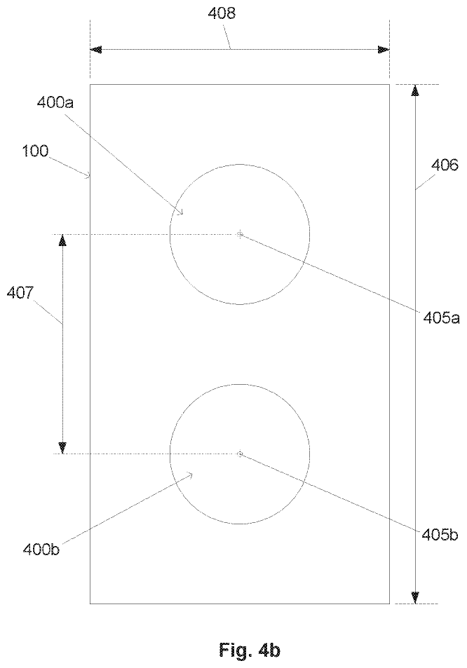

FIG. 4a illustrates the fixture 100 without the locking device 130, for example, after the locking device 130 has been completely removed from the fixture 100. The fixture 100 can have a second dimension 406 and a third dimension 408. The second dimension 406 can be the distance between the exterior fifth and sixth surfaces 52e, 52f. The second dimension 406 can correspond to a height of the fixture 100. The second dimension 406 can range from about 8 cm to about 30 cm or more, including every 0.1 cm increment within this range (e.g., 15.0 cm, 17.6 cm, 20.0 cm). The third dimension 408 can be the distance between the exterior third and fourth surfaces 52c, 52d. The third dimension 406 can correspond to a length of the fixture 100. The third dimension 406 can range from about 8 cm to about 30 cm or more, including every 0.5 cm increment within this range (e.g., 15.0 cm, 15.5 cm, 16.0 cm, 20.0 cm), or for example about 17.6 cm. The second and third dimensions 406, 408 can be the same or different from one another. For example, the second and third dimensions 406, 408 can each be about 17.6 cm. The first, second and third dimensions 200, 406, 408 can be mutually perpendicular to one another or can be at lesser or greater angles relative to one another.

The fixture 100 can have a first bore 400 and a second bore 404 (also referred to as a cross-bore or the bolt bore configured to hold a length of the bolt) extending laterally from the first bore 400. The first bore 400 can extend from a fixture first longitudinal end to a fixture second longitudinal end along a fixture longitudinal axis. The fixture longitudinal axis can be a center longitudinal axis of the fixture 100. For example, the first bore 400 can extend through the exterior first and second surfaces 52a, 52b along the fixture longitudinal axis. The fixture longitudinal axis can be straight or curved. The cross-bore 404 can be perpendicular to the first bore 400. The cross-bore 404 can extend along a fixture transverse axis. For example, the cross-bore 404 can extend through the exterior third surface 52c along the fixture transverse axis. The fixture transverse axis can be straight or curved.

The first bore 400 can have a regular or irregular geometric shape and can be defined by one or multiple package assembly interior surfaces 54 (e.g., 1 to 10 or more interior surfaces). The package assembly interior surfaces 54 can be interior surfaces of the fixture 100. Each interior surface 54 can be planar and/or curved. The second bore 404 can have a regular or irregular geometric shape and can be defined by one or multiple package assembly interior surfaces 56 (e.g., 1 to 10 or more interior surfaces). The package assembly interior surfaces 56 can be interior surfaces of the fixture 100. Each interior surface 56 can be planar and/or curved. For example, the first and/or second bore 400, 404 can have a polyhedral shape (e.g., square cuboid, rectangular cuboid, parallelepiped), a frustum shape (e.g., conical frustum, pyramidal frustum), a cylindrical shape, or any combination thereof. The first bore 400 can straight and/or tapered. The second bore 404 can be straight and/or tapered.

The first bore 400 can have a first bore dimension 402 of about 1.000 inches to about 3.000 inches, including every 0.125 inch increment within this range (e.g., about 2.125 inches). The first bore dimension 402 can be the maximum dimension across the first bore 400, for example, as measured perpendicular to the first bore longitudinal axis. For example, the first bore dimension 402 can be the diameter of the first bore 400.

The second bore 404 can have a second bore dimension 412 of about 0.500 inches to about 2.000 inches, including every 0.125 inch increment within this range (e.g., about 1.000 inches). The second bore dimension 412 can be the maximum dimension across of the second bore 404, for example, as measured perpendicular and/or parallel to the first bore longitudinal axis. For example, the second bore dimension 412 can be collinear with the first bore longitudinal axis.

A center of the first bore 400 can be a dimension 414 from the side of the fixture 100 configured to removably receive the deadbolt assembly 132 (e.g., the side having the exterior third surface 52c). The dimension 414 can be about 2.000 inches to about 3.000 inches, including every 0.125 inch increment within this range (e.g., about 2.375 inches, about 2.750 inches).

A portion of the locking device 130 can be configured to be in the first bore 400 and/or in the second bore 404 when the package assembly 50 is in a partially or fully assembled configuration. For example, a portion of the device first side 130a and a portion of the device second side 130b can be in the first bore 400 when the package assembly 50 is in an assembled configuration (e.g., the assembled configuration of FIG. 1). A portion of the deadbolt assembly 132 can be configured to be in the first bore 400 and/or in the second bore 404 when the package assembly 50 is in a partially or fully assembled configuration. For example, a first portion of the deadbolt assembly 132 can be in the first bore 400 and a second portion of the deadbolt assembly 132 can be in the second bore 404 when the package assembly 50 is in an assembled configuration (e.g., the assembled configuration of FIG. 1). The locking device 130 can clamp onto a first and second side (e.g., the front and back) of the fixture 100 adjacent to the first bore 400. The locking device 130 can fit into the first bore with a magnetic fit, snap fit, friction fit, screw fit, loose fit, or any combination thereof. The lock longitudinal axis can be parallel or collinear with the center longitudinal axis of the first bore 400.

The fixture 100 can have a mortise 410 for the faceplate 122. The mortise 410 can be, for example, rectangular, round, or oval. The manufacturing process of the fixture 100 can include the use of a mortising machine or router.

FIG. 4b illustrates that the third dimension 408 (e.g., width) can be twice the second dimension 406 (e.g., height) of the fixture 100. The fixture can have a top first bore 400a and a bottom first bore 400b. The top first bore 400a can have the same (as shown) or a different first bore dimension 402 (e.g., diameter) than the first bore dimension (e.g., diameter) of the bottom first bore 400b. The top first bore center 405a can be spaced apart from the bottom first bore center 405b in the direction of the second dimension 406 (e.g. height) by a center-to-center bore spacing 407. The center-to-center bore spacing 407 can be from about 20% to about 80% of the second dimension 406, more narrowly from about 30% to 50%, for example about 40%. The center-to-center bore spacing 407 can be from about 7 cm to about 28 cm, more narrowly from about 11 cm to about 17 cm, for example about 14 cm (5.5 in.).

The top first bore 400a and bottom first bore 400b can together be centered along the length of the third dimension 408 of the fixture 100. Separate locking devices 130 can be mounted in each of the top first bore 400a and the bottom first bore 400b. A locking device 130 can be mounted in one of the top first bore 400a or the bottom first bore 400b, and the remaining first bore can be left empty. A door handle can be mounted in one of one of the top first bore 400a or the bottom first bore 400b, and the locking device 130 can be mounted in the remaining first bore. Separate door handles can be mounted in each of the top first bore 400a and the bottom first bore 400b.

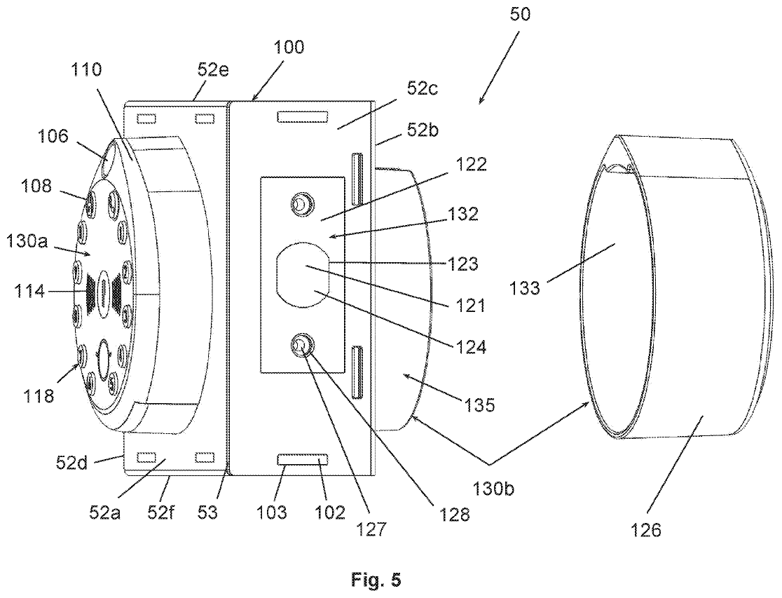

FIG. 5 illustrates the package assembly 50 in a partially disassembled or a partially assembled configuration. For example, FIG. 5 illustrates the fasteners 129 detached from the package assembly 50, exposing the fastener channels 127 and attachment holes 128. FIG. 5 further illustrates a portion of the device second side 130b detached from the package assembly (e.g., from the locking device 130 and/or from the fixture 100). For example, FIG. 5 illustrates the lock back enclosure 126 detached from a deadbolt knob 135. The lock back enclosure 126 can be removed from the package assembly 50 (e.g., from the locking device 130 and/or from the fixture 100) with or without the use of tools. The lock back enclosure 126 can be attached to the package assembly 50 (e.g., to the locking device 130 and/or to the fixture 100) with or without the use of tools.

FIG. 5 illustrates that the locking device 130 can include a deadbolt knob 135. Removing the lock back enclosure 126 from the package assembly 50 can expose the deadbolt knob 135. The lock back enclosure 126 can be removed from the package assembly 50 by detaching the lock back enclosure 126 from the deadbolt knob 135. The lock back enclosure 126 can fit over the deadbolt knob 135 such that the deadbolt knob 135 is exposed when the lock back enclosure 126 is removed from the device 130. For example, the lock back enclosure 126 can have a recess 133 configured to receive the deadbolt knob 135. The lock back enclosure 126 can be directly or indirectly attached to the deadbolt knob 135, for example, with a magnetic fit, snap fit, friction fit, screw fit, loose fit, or any combination thereof. For example, magnets and/or geometric features such as ridges, snaps, clasps, hooks, or combinations thereof, in or on the lock back enclosure 126 and/or the remainder of the locking device 130 can be used to removably attach the lock back enclosure 126 to the remainder of the device 130 (e.g., to the deadbolt knob 135 and/or to a connector).

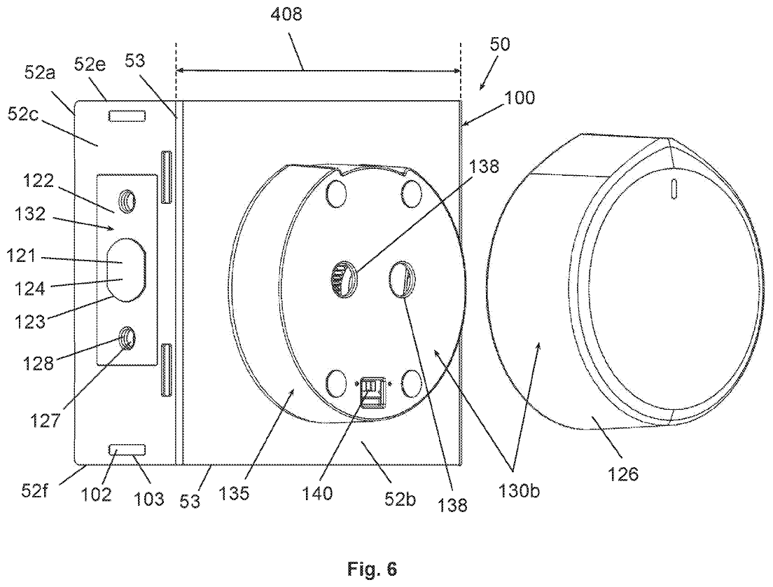

FIG. 6 illustrates that the deadbolt knob 135 can have one or multiple knob ports 138 and a body connector 140. During disassembly, a tool, such as a screwdriver, can be inserted through the knob ports 138 to remove, deactivate, unfasten or loosen attachment elements such as screws that can attach internal elements of the locking device 130 together, for example, connectors of the device first and/or second sides 130a, 130b. During assembly, a tool, such as a screwdriver, can be inserted through the knob ports 138 to insert, activate, fasten or tighten attachment elements such as screws that can attach internal elements of the locking device 130 together, for example, connectors of the device first and/or second sides 130a, 130b. The lock back enclosure 126 can have a lock back enclosure connector (not shown) configured to removably attach to the body connector 140. The lock back enclosure connector can be a battery connector. For example, FIG. 6 illustrates that the lock back enclosure 126 can be configured to be removably attached to the locking device 130 via engagement of a lock back enclosure battery connector to the body connector 140.

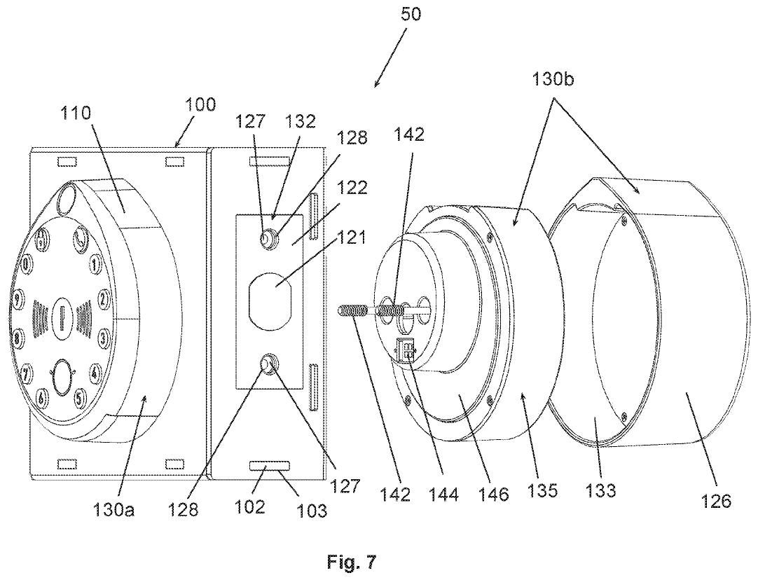

FIG. 7 illustrates the package assembly 50 in a partially disassembled or a partially assembled configuration. For example, FIG. 7 illustrates the deadbolt knob 135 detached from the package assembly 50. The deadbolt knob 135 can have one or multiple device second side connectors 142, a rear mating PCB 144, and a device back baseplate 146. The connectors 142 can be alignment and connection elements. The connectors 142 can have screw threads. The deadbolt knob 135 can be removably attached to the device first side 130a with the connectors 142, for example, to one or more device first side connectors (not shown). The deadbolt knob 135 can be removably attached to the deadbolt assembly 132 with the connectors 142, for example, to one or more connectors or holes of the deadbolt assembly 132.

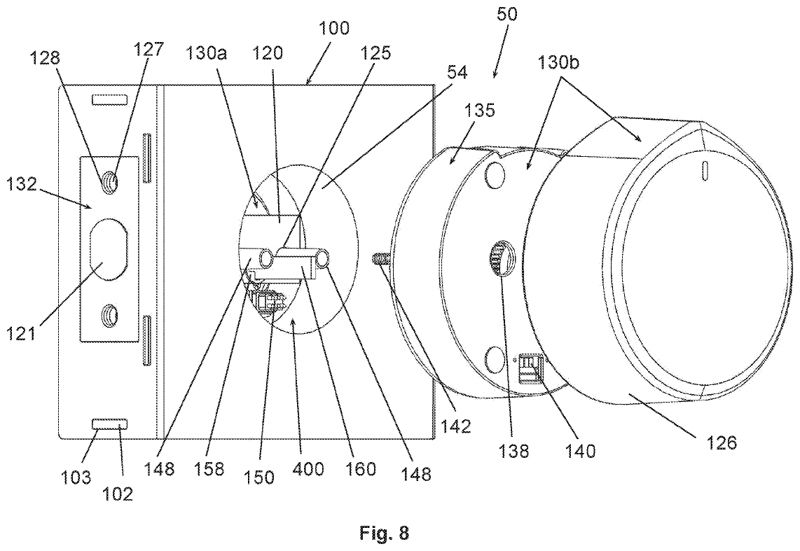

FIG. 8 illustrates that the device first side 130a can have one or multiple device first side connectors 148 and a bridge connector PCB 150. The connectors 148 can be alignment and connection elements. One or more of the device first side connectors 148 and/or one or more of the device second side connectors 142 can be male connectors. One or more of the device first side connectors 148 and/or one or more of the device second side connectors 142 can be female connectors. The male connectors can be configured to be inserted into or received by a corresponding female connector. For example, FIGS. 7 and 8 illustrate that the device second side connectors 142 can be male connectors and that the device first side connectors 148 can be female connectors, or vice versa. The male connectors can be fasteners (e.g., screws), rods, tapered rods, magnets, or any combination thereof. The female connectors can be female fasteners (female screws), channels, tapered channels, magnets, or any combination thereof. The device first and second sides 130a, 130b can be removably attached to one another via the device first and second side connectors 148, 142. The device first and second side connectors 148, 142 can be removably attached to one another, for example, with a magnetic fit, snap fit, friction fit, screw fit, loose fit, or any combination thereof. The bridge connector PCB 150 can mate with the rear mating PCT 144 when the deadbolt knob 135 is attached to the device first side 130a, for example, via the connectors 142 and 148.

The device first and second sides 130a, 130b can be removably attached to the fixture 100 via engagement between the device first and second side connectors 148, 142.

FIGS. 7 and 8 illustrate that the locking device 130 can have two connectors 142 and two connectors 148.

During disassembly of locking device 130 from the package assembly 50 or a door, a tool, such as a screwdriver, can be inserted through the knob ports 138 to remove, deactivate, unfasten, or loosen the device second side connectors 142 from the device first side connectors 148. During assembly of the locking device 130 to the fixture 100 or a door, a tool, such as a screwdriver, can be inserted through the knob ports 138 to insert, activate, fasten, or tighten the device second side connectors 142 to the device first side connectors 148.

FIG. 8 further illustrates that the deadbolt assembly 132 can have a deadbolt proximal end 120 and a tailpiece receiver 158. The deadbolt proximal end 120 can have one or more deadbolt assembly connector holes 125. The deadbolt proximal end 120 can be in the bore 400. FIG. 8 illustrates that the connectors 148 and/or the connectors 142 can extend through the connector holes 125 of the deadbolt proximal end 120 to secure the deadbolt proximal end 120 in a fixed position relative to the movable deadbolt distal end 124 when the device first side 130a is attached to the deadbolt proximal end 120 (e.g., via connectors 148), when the device second side 130b is attached to the deadbolt proximal end 120 (e.g., via connectors 142), when the device first end 130a and the deadbolt assembly 132 are removably attached to one another, or any combination thereof.

FIG. 8 further illustrates that the device first side 130a can have a deadbolt tailpiece 160 that can extend through the tailpiece receiver 158 when the device first end 130a and the deadbolt assembly 132 are removably attached to one another.

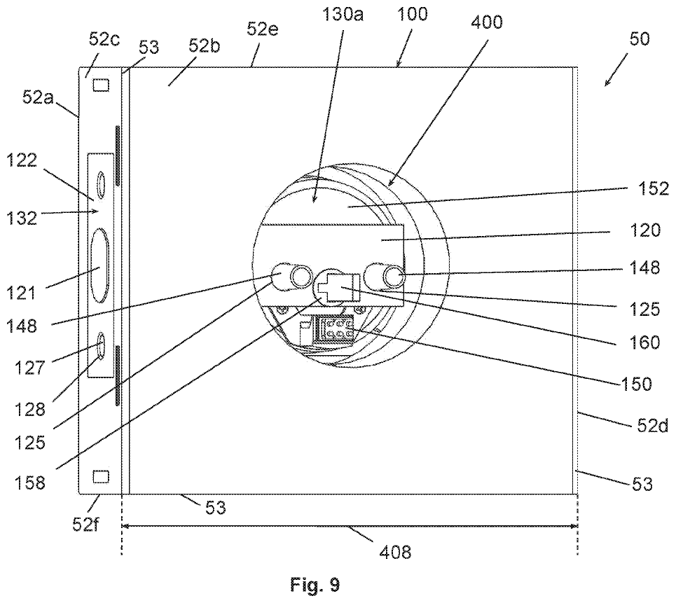

FIG. 9 illustrates that the device first side 130a can have a device front baseplate 152.

FIGS. 7-9 illustrate that the deadbolt knob 135 can be removably attached to the deadbolt assembly 132 via the connectors 142 and 148.

When the deadbolt knob 135 is removably attached to the package assembly 50 (e.g., to the fixture 100, to the device first side 130a, and/or to the deadbolt assembly 132), the deadbolt knob 135 can extend rearward away from the fixture 100 (e.g., away from the device first side 130a). When the deadbolt 121 is in an unlocked position retracted into the fixture 100, a battery pack alignment feature (also referred to as a lock back enclosure alignment feature) can be pointed toward the top of the locking device 130 (e.g., toward the exterior fifth surface 50e).

Rotation of the deadbolt knob 135 in a first direction can extend the deadbolt 121 out of the fixture 100 into a locked position. Rotation of the deadbolt knob 135 in a second direction opposite the first direction can retract the deadbolt 121 into the fixture 100 into an unlocked position. The deadbolt knob 135 can be rotated via the keyway 112 or via the lock back enclosure 126 when the lock back enclosure 126 is on the deadbolt knob 135. For demoing the packaging fixture 100 a key can be inserted into the keyway 112 to unlock the packaging fixture 100, for example as with a pin tumbler lock. The key can be a metal key, a key shaped as a credit card, or any other type of key.

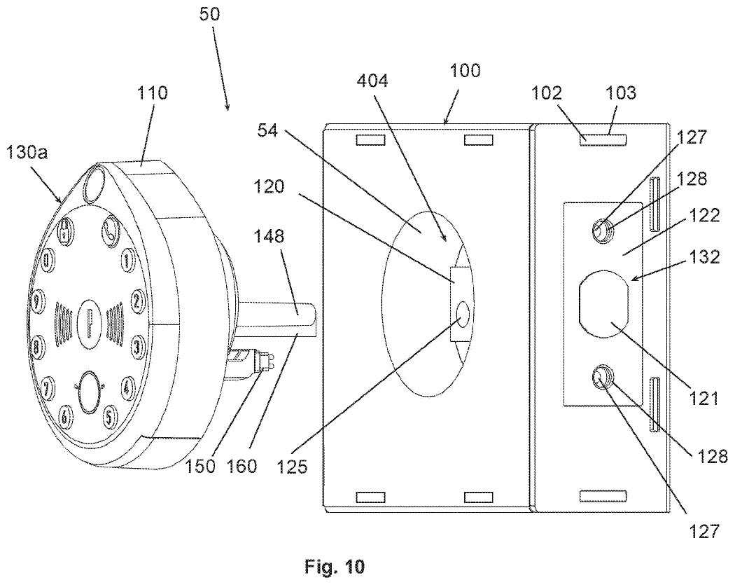

FIG. 10 illustrates the package assembly 50 in a partially disassembled or a partially assembled configuration. For example, FIG. 10 illustrates the device first side 130a detached from the package assembly 50 (e.g., from the fixture 100 and/or the deadbolt assembly 132).

FIG. 10 further illustrates that the fasteners 129 can be removed after the device first and second sides 130a, 130b are removed from the fixture 100.

FIG. 11 illustrates the package assembly 50 in a partially disassembled or a partially assembled configuration. For example, FIG. 11 illustrates the fasteners 129 detached from the package assembly 50 (e.g., from the fastener channels 127 and the faceplate attachment holes 128).

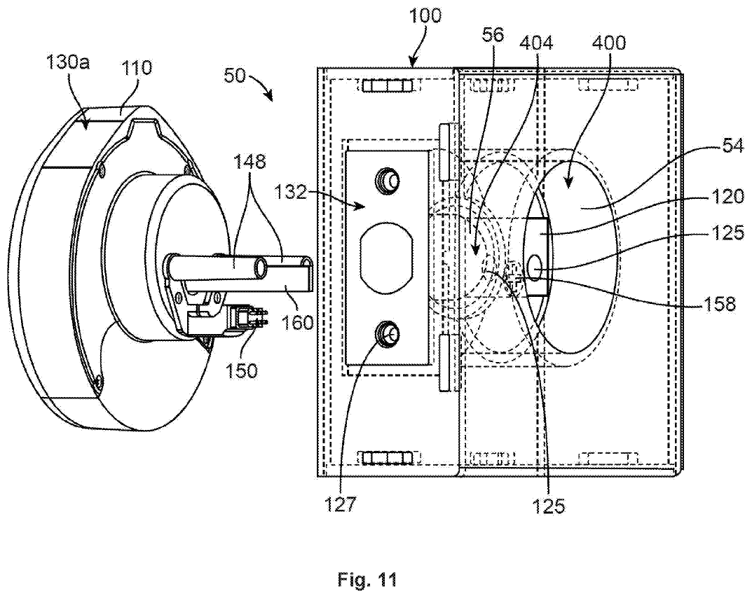

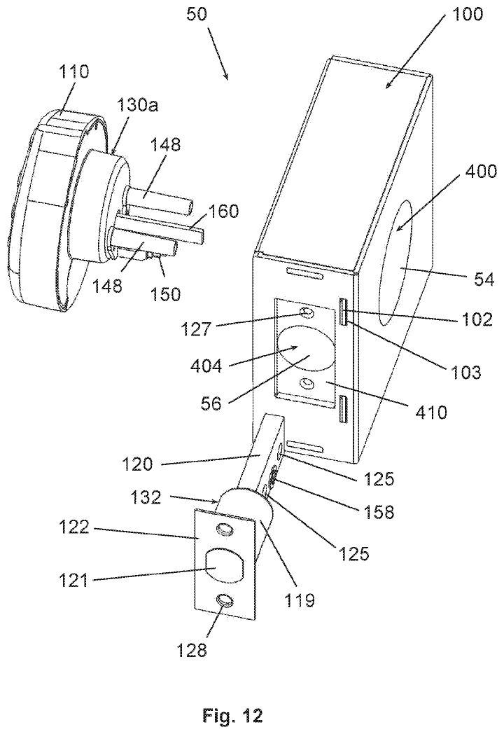

FIG. 12 illustrates the package assembly 50 in a fully disassembled configuration. For example, FIG. 12 illustrates the deadbolt assembly 132 detached from the package assembly 50 (e.g., from the first and second bores 400, 404). FIG. 12 further illustrates that the deadbolt assembly 132 can have a deadbolt enclosure 119 in which the deadbolt 121 can extend from and retract within (from an extended position). FIG. 12 illustrates the deadbolt 121 in an unlocked position retracted within the deadbolt enclosure 119. The deadbolt enclosure 119 can be positioned in the second bore 404 when the package assembly 50 is in a partially or fully assembled configuration.

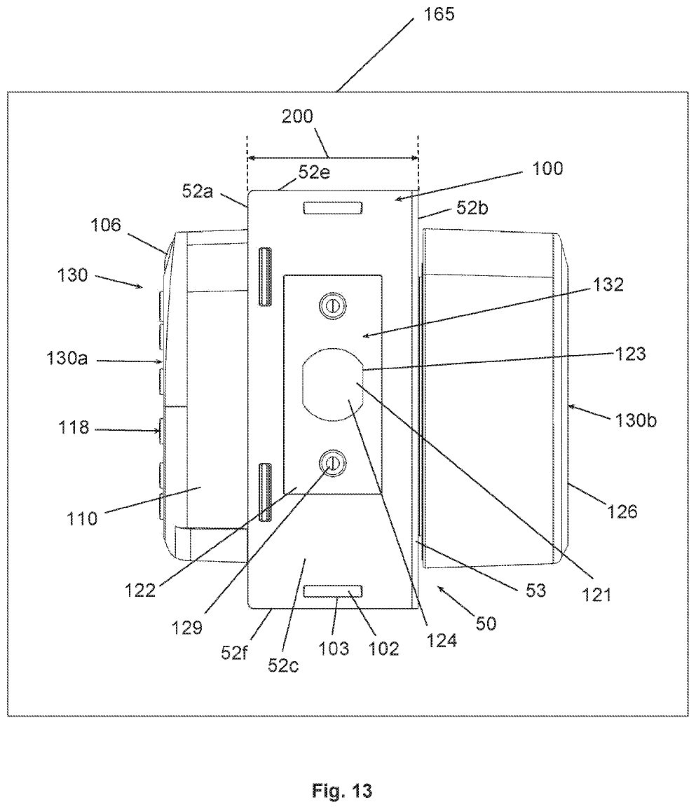

FIG. 13 illustrates the package assembly 50 in a box 165. The package assembly 50 can be in the box in a partially or fully assembled configuration. For example, FIG. 13 illustrates that the device 130 can be in a fully assembled configuration on the fixture 100 when the device 130 is in the box 165. The box 165 having the package assembly 50 can be shipped to users. The box 165 having the package assembly 50 can be a retail box purchasable by users.

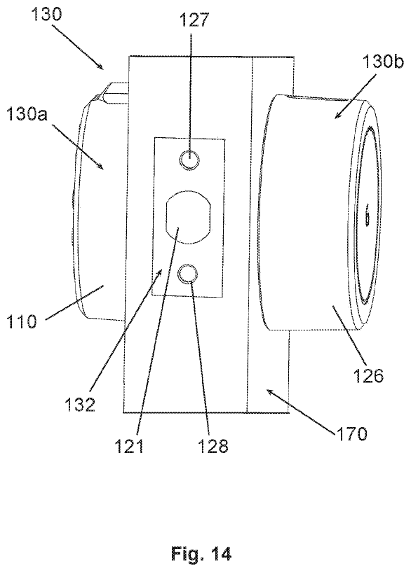

FIG. 14 illustrates the locking device 130 reassembled or installed on a door 170 having first and second bores sized similarly to the first and second bores 400, 400 of the fixture 100. The door bores (not shown) can be modified if too small to accommodate the device 130, for example, with a hole saw and jig, a file, or any combination thereof.

Method of Use—Demo System

The locking device 130 can be delivered to purchasers (e.g., customers, users) attached to the fixture 100. Purchasers can buy the locking device 130 attached to the fixture 100. The package assembly 50 can be in product packaging of the locking device 130 in a partially or fully assembled configuration. For example, the package assembly 50 can be in a retail box, or in a box delivered to a user. The product packaging can include an instruction manual to disassemble the locking device 130 from the fixture and to reassemble the locking device 130 to the door 170.

The user can download a software application associated with the locking device 130 on a computer (e.g., onto a smartphone). The user can connect the locking device 130 to a network (e.g., public WiFi, home Wifi, a hotspot). The software application can walk the user through the various functions of the device 130 while the device 130 is still attached to the fixture 130.

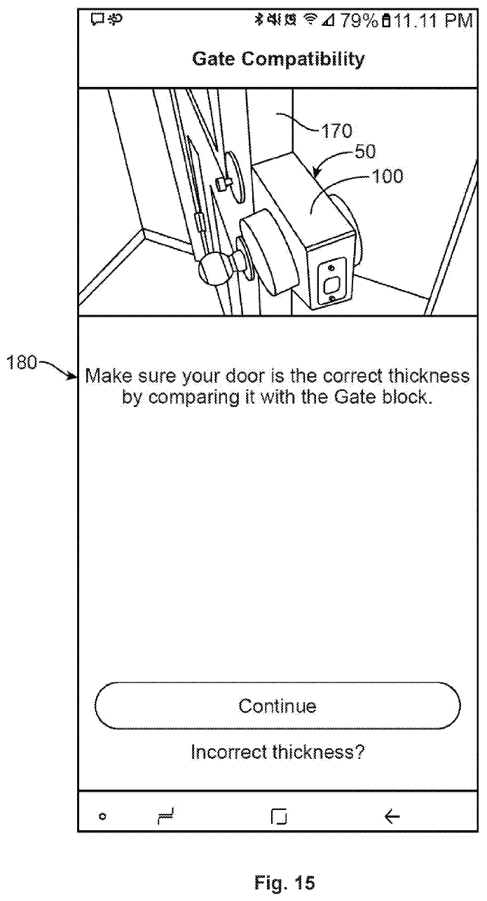

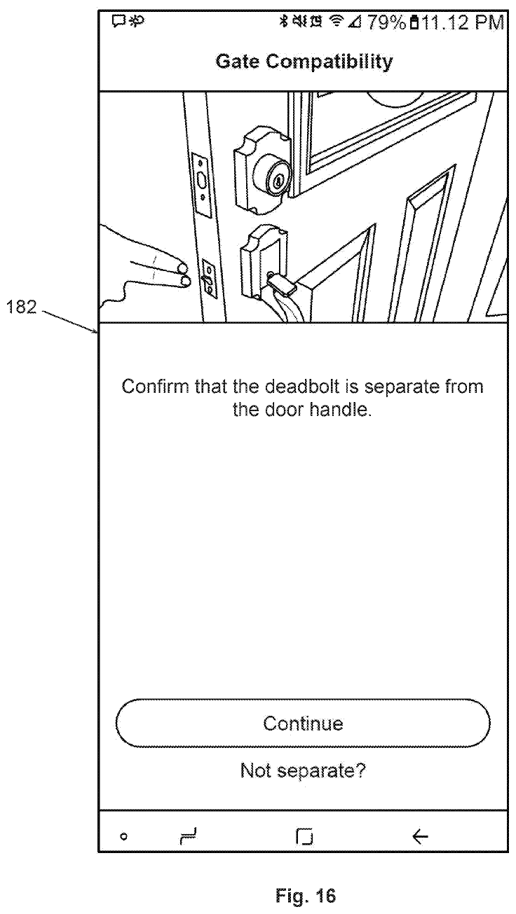

FIGS. 15 and 16 illustrate that the software application can guide a user through part or all of the installation process using the package assembly 50. For example, FIGS. 15 and 16 illustrate that the software can guide the user through a compatibility check to verify that the locking device 130 is compatible with the door 170. FIG. 15 illustrates that the compatibility check can include having the user confirm that the door is the correct thickness (e.g., has a thickness about the same as the dimension 200). For example, FIG. 15 illustrates a screenshot 180 of a computer (e.g., a smartphone) running the software in which the user is being queried to verify that the door 170 is the correct thickness by comparing the package assembly 50 against the door 170. The screenshot 180 shows an exemplary package assembly being held against an exemplary door to show the user how to confirm that the door 170 is the correct thickness. The screenshot 180 illustrates that the user interface can give the user the option to continue if the door 170 is the correct thickness (e.g., if the door is approximately the same thickness as the fixture 100) or to select a link titled “Incorrect thickness?” if the door 170 is not the correct thickness or if the user believes the door 170 is not the correct thickness. If the user selects the “Incorrect thickness?” option, various questions or recommendations can be presented to the user to help verify the user's needs.

As another example, FIG. 16 illustrates a screenshot 182 in which the user is queried to confirm that the deadbolt of the door 170 is separate from the door handle. The screenshot 182 illustrates that the user interface can give the user the option to continue if the door is the deadbolt is separate (e.g., if the deadbolt is not controllable via the handle of the door 170) or to select a link titled “Not separate?” if the deadbolt is not separate from the door handle or if the user believes the deadbolt is not separate from the door handle. If the user selects the “Not separate?” option, various questions or recommendations can be presented to the user to help verify the user's needs.

The image on the screenshots 180 and 182 can be a still image or part of a video.

The features of the locking device 130 can be exercised while the locking device 130 is removably attached to the packaging fixture 100. These features can include, for example, locking and unlocking of the locking device 130 with a physical key and remote locking and unlocking of the locking device 130 with an electronic signal. These features can include, for example, using the camera 106, the lock button 108, the keyway 112, the numerical keys 118, the IR motion sensor, or any combination thereof.

The packaging fixture 100 can provide a do-it-yourself (DIY) installation user experience. The user can gain experience with removal of the locking device 130 from the packaging fixture 100. The user can also practice installation of the locking device 130 on the packaging fixture 100 prior to installation on a door 170. The door 170 can be, for example, a rotating hinged door 170. This technology allows users to become familiar with the lock and associated software applications while the device 130 is attached to the packaging fixture 100 and before the device 130 is installed on a door 170.

Being able to use and explore the functions of the locking device 130 while attached to the fixture can make users more comfortable and confident replacing their door locks with the locking device 130.

The locking device 130 can be disassembled from the fixture 100 and installed on a door.

FIGS. 1 and 2 illustrate the locking device 130 attached to the packaging fixture 100. FIG. 1 illustrates the package assembly 50 without the fasteners 129 and FIG. 2 illustrates the package assembly 50 with the fasteners 129.

FIGS. 1 and 2 illustrate the package assembly 50 in a fully assembled configuration (less the fasteners 129 in FIG. 1).

The package assembly 50 can be disassembled by detaching the device first side 130a, detaching the device second side 130b, and detaching the deadbolt assembly 132 from the fixture 100.

For example, FIGS. 5-12 illustrate a variation of a process of removing the locking device 130 from the fixture 130, including: removing the lock back enclosure 126 (FIGS. 5 and 6), removing the deadbolt knob 135 (FIGS. 7-9), removing the device first side 130a (FIGS. 10 and 11), and removing the deadbolt assembly 132 (FIG. 12). These steps can be executed in any order, for example, in the order listed.

Removing the lock back enclosure 126 can involve detaching a lock back enclosure connector (e.g., a battery connector) from the body connector 140. Removing the lock back enclosure 126 can also involve sliding the lock back enclosure 126 over the deadbolt knob 135.

Removing the deadbolt knob 135 can involve detaching the device second side connectors 142 from the device first side connectors 148, for example, by removing the connectors 142 from the connectors 148. Removing the deadbolt knob 135 can also involve detaching the device second side connectors 142 from the deadbolt assembly connector holes 125, for example, by sliding the connectors 142 out of the connector holes 125. Removing the deadbolt knob 135 can also involve removing the connectors 142 from the first bore 400, for example, by sliding the connectors 142 out of the first bore 400.

Removing the device first side 130a can involve removing the lock front enclosure 110. Removing the device first side 130a can involve detaching the device first side connectors 148 from the deadbolt assembly connector holes 125, for example, by sliding the connectors 148 out of the connector holes 125. Removing the device first side 130a can also involve detaching the deadbolt tailpiece 160 from the tailpiece receiver 158, for example, by sliding the deadbolt tailpiece 160 out of the tailpiece receiver 158. Removing the device first side 130a can also involve removing the connectors 148 from the first bore 400, for example, by sliding the connectors 148 out of the first bore 400.

Removing the deadbolt assembly 132 can involve detaching the fasteners 129. Removing the deadbolt assembly 132 can also involve removing the deadbolt assembly 132 from the first and second bores 400, 404, for example, by sliding the deadbolt assembly 132 out of the first and second bores 400, 404.

FIG. 4a illustrates the packaging fixture 100 with the locking device 130 completely removed.

The device 130 can be installed on a fixture (e.g., the fixture 100) or to a door (e.g., the door 170). The device 130 can be installed by attaching the device first side 130a, attaching the device second side 130b, and attaching the deadbolt assembly 132 to the fixture 100, to a door, and to each other.

For example, the process of installing the locking device 130 to a fixture 100 or a door 170 can include: attaching the deadbolt assembly 132, attaching the device first side 130a, attaching the deadbolt knob 135, and attaching the lock back enclosure 126. These steps can be executed in any order, for example, in the order listed.

Attaching the deadbolt assembly 132 can involve inserting the deadbolt assembly into the first and second bores 400, 404. For example, FIGS. 10 and 11 show that the deadbolt proximal end 120 can be slid through the second bore 404 and into the first bore 400 such that the face plate 122 makes contact with the face plate recess 410 on the lateral face (e.g., the exterior third side 52c) of the fixture 100 or the door 170. Attaching the deadbolt assembly 132 can also involve securing the faceplate 122 to the fixture 100 or to the door 170 with fasteners 129. The fasteners 129 can hold the deadbolt assembly 132 in place in the packaging fixture 100 or door 170.

Attaching the device first side 130a can involve attaching the lock front enclosure 110. Attaching the device first side 130a can involve attaching the device first side connectors 148 to the deadbolt assembly connector holes 125, for example, by sliding the connectors 148 into the connector holes 125. Attaching the device first side 130a can also involve attaching the deadbolt tailpiece 160 to the tailpiece receiver 158, for example, by sliding the deadbolt tailpiece 160 into the tailpiece receiver 158 (e.g., as shown in FIG. 9). The device first side 130a can be installed so that the lock front enclosure 110 is flush with the fixture 100 (e.g., the exterior first surface 52a) or the door 170. Attaching the device first side 130a can also involve inserting the connectors 148 into the first bore 400, for example, by sliding the connectors 148 into the first bore 400.

Attaching the deadbolt knob 135 can involve attaching the device second side connectors 142 to the device first side connectors 148, for example, by attaching the connectors 142 and 148 together. For example, FIGS. 7 and 8 show that the connectors 142 148 can be aligned and fastened (e.g., screwed) together so that the deadbolt knob 135 is flush with the fixture 100 (e.g., the exterior second surface 52b) or the door 170. Attaching the deadbolt knob 135 can also involve attaching the device second side connectors 142 to the deadbolt assembly connector holes 125, for example, by sliding the connectors 142 into the connector holes 125. Attaching the deadbolt knob 135 can also involve inserting the connectors 142 into the first bore 400, for example, by sliding the connectors 142 into the first bore 400.

The connectors 142 and 148 can be attached to one another within or outside of the first bore 400.

Attaching the lock back enclosure 126 can involve attaching a lock back enclosure connector (e.g., a battery connector) to the body connector 140. Attaching the lock back enclosure 126 can also involve sliding the lock back enclosure 126 over the deadbolt knob 135. For example, FIGS. 5 and 6 show the alignment of the lock back enclosure 126 with the deadbolt knob 135 prior to the lock back enclosure being attached to the deadbolt knob 135. FIGS. 1-3 illustrate the lock back enclosure 126 attached to the deadbolt knob 135.

FIGS. 1 and 2 illustrate the locking device 130 attached to the packaging fixture 100. FIG. 1 illustrates the package assembly 50 without the fasteners 129 and FIG. 2 illustrates the package assembly 50 with the fasteners 129. The connectors 142 and 148 can be attached to one another within or outside of the first bore 400 in FIGS. 1 and 2.

FIG. 14 illustrates the locking device 130 reassembled onto the door 170, for example, using the above installation instructions.

Deadbolt System

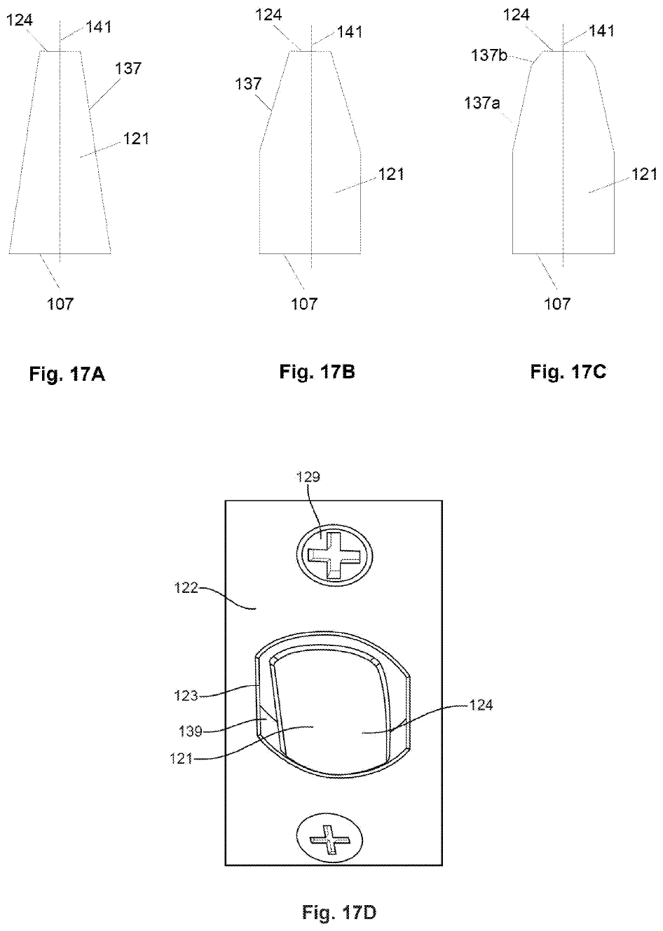

FIG. 17A illustrates that the deadbolt 121 can have a taper 137. One or multiple sides of the deadbolt 121 can have a taper 137 (e.g., 1, 2, 3, 4, or more sides). The deadbolt 121 can have a tapered shape such as a conical frustum or a polygonal frustum (e.g., pyramidal frustum). Different deadbolt sides can have the same or different taper 137. The taper 137 can extend from a deadbolt proximal terminal end 107 to the deadbolt distal terminal end 124 (e.g., along an entire length of the deadbolt 121). The taper 137 can have a taper angle measured relative to a deadbolt longitudinal axis 141. The taper angle can be from about 5 degrees to about 85 degrees, including every 1 degree increment within this range (e.g., 10 degrees, 15 degrees, 30 degrees, 45 degrees). The deadbolt longitudinal axis 141 can be straight or curved. The deadbolt longitudinal axis 141 can be a center deadbolt longitudinal axis.

Tapered deadbolts 121 can be configured to help with misalignment (e.g., horizontal misalignments) between the locking device 131 and a deadbolt receiver. The deadbolt receiver can be positioned opposite the deadbolt 121 in a door frame. The deadbolt receiver can receive a portion of the deadbolt 121 (e.g., a distal end of the deadbolt 121) when the locking device 130 is in a locked configuration. The tapered surfaces 137 can be configured to guide the deadbolt 121 into the deadbolt receiver, for example, by sliding along an edge of the deadbolt receiver when the deadbolt 121 and the deadbolt receiver are misaligned.

FIG. 17B illustrates that the taper 137 can extend less than the entire length of the deadbolt 121. For example, the taper 137 can extend along about 5% to about 95% of the length of the deadbolt 121, including every 1% increment within this range (e.g., 20%, 25%, 33%, 40%, 50%, 60%, 66%, 75%, 80%, 90%). FIG. 17B illustrates that the taper 137 can extend about half the length of the deadbolt 121.

FIG. 17C illustrates that the deadbolt 121 can have multiple tapers, for example, a first taper 137a and a second taper 137b. The first taper 137a can be tapered less than the second taper 137b, or vice versa. For example, the taper angle of the first taper 137a can be less than the taper angle of the second taper 137b, or vice versa.

FIG. 17D illustrates that the deadbolt distal terminal end can have a rounded rectangle shape (also referred to as a stadium shape). A gap 139 can be between the deadbolt 121 and the surface defining the opening 123 as a result of the one or more tapers 137.

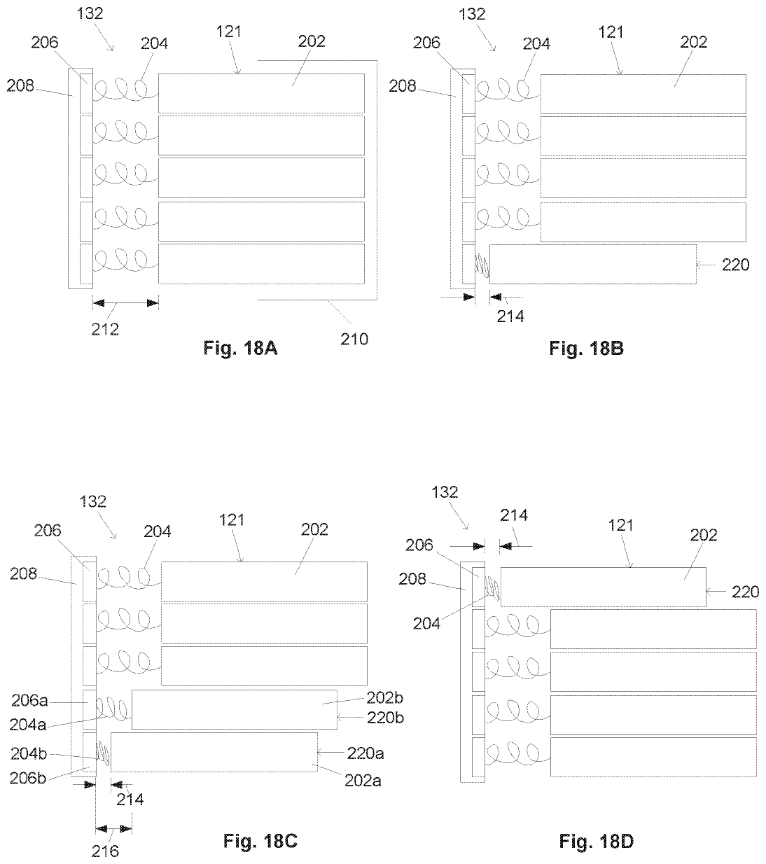

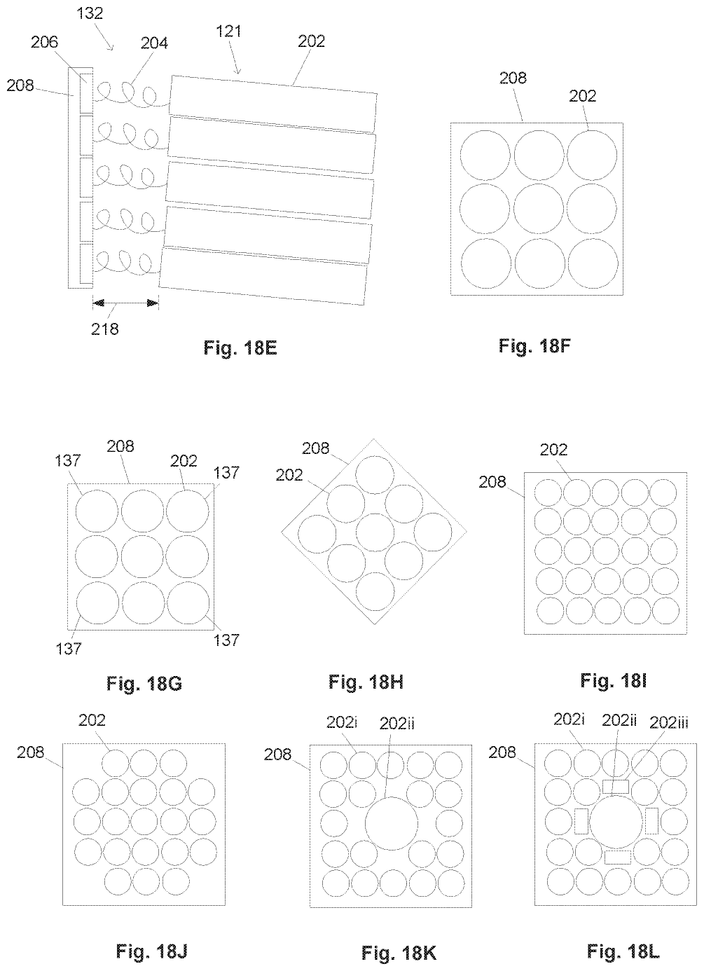

FIG. 18A illustrates that the deadbolt 121 can be a mesh of spring-loaded rods 202 (also referred to as a multi-rod deadbolt). For example, FIG. 18A illustrates that the deadbolt assembly 132 can have rods 202, springs 204, sensors 206, and a panel 208. The mesh of rods can include 2 to 50 or more rods 202, including every 1 rod increment within this range (e.g., 3 rods, 4 rods, 6 rods, 9 rods, 10 rods, 12 rods, 15 rods). The rods 202 can be connected to the sensors 206 via the springs 204. The sensors 206 can be integrated with or attached to the panel 208. Additionally or alternatively, the sensors 206 can be attached to or integrated with the rods 202. The panel 208 can be configured to be positioned in the first bore 400 or the second bore 404.

The panel 208 can be manually and/or automatically articulated to move the rods 202 back and forth between locked and unlocked positions. For example, the panel 208 can be moved back and forth via the deadbolt tailpiece 160 and the tailpiece receiver 158.

The panel 208 can collectively move the mesh of rods 202 such that the rods 202 can move like a single deadbolt 121. When the rods 202 are advanced from an unlocked position to a locked position, the springs 204 can allow the movement of each rod 202 to be individually resisted or prevented by surfaces such as the door frame, the deadbolt receiver, an obstruction in the deadbolt receiver, or any combination thereof. When movement of a rod 202 from an unlocked position to a locked position is resisted or prevented, the spring 204 can become compressed. The individual resistance of each of the rods 202 can allow the deadbolt assembly 132 to lock a door (e.g., door 170) even when the locking device and door 130, 170 are misaligned since the rods 202 unaffected and/or partially affected by the misalignment can still extend into the deadbolt receiver to lock the door 170.

The sensors 206 can be configured to measure the force exerted on the springs 204, for example, when movement of the rods 202 is inhibited or prevented. The sensors 206 can be configured to measure the force on the springs 206 when the springs 204 are compressed or extended as a result of the rods 202 not moving or moving a different amount (e.g., a lesser distance) than the panel 208. The sensors 206 can be configured to read the force on the springs 204 to determine whether or not the rods 202 are properly engaged (e.g., extended) in a locked position. The springs 204 can have a neutral position when the rods 202 are not pressed toward the sensors 206 and/or toward the panel 208 (e.g., when movement of the rods 202 is not resisted). The force on the springs 204 can be 0 Newtons or a non-zero calibrated value when the springs 204 are in a neutral position. FIG. 18A illustrates the springs 204 in neutral positions. FIG. 18A illustrates a configuration of the deadbolt assembly 132 when the mesh of rods 202 is fully aligned with a deadbolt receiver 210.

FIG. 18A illustrates that the springs 204 can have a neutral length 212 of about 0.500 inches to about 1.500 inches, including every 0.125 inch increment within this range (e.g., 1.000 inches).

The mesh spring-loaded rods 202 and the sensors 206 can be used to determine when the locking device 130 and the deadbolt receiver 210 are misaligned. The rods and sensors 202, 206 can also be used to determine the direction of the misalignment. Misalignment information can be communicated to the user. Recommended solutions to the misalignment can be communicated to the user (e.g., via the locking device 130, a user computer) so that the user can fix it. One or more processors of the locking device 130 can analyze data from the sensors 206. Additionally or alternatively, the sensor data can be analyzed by a remote server or a backend system of the locking device 130.

FIG. 18B illustrates a resistive force 220 inhibiting or preventing one rod 202 from partially or fully extending into the deadbolt receiver 210. The spring 204 of the affected rod 202 can be compressed to a compressed length 214 of about 0.0625 inches to about 0.2500 inches, including every 0.0625 inch increment within this range (e.g., about 0.0625 inches). The other rods 202 can lock the locking device 130 to the door 170. The springs 204 of the other rods 202 can be in a neutral position. The misalignment illustrated in FIG. 18B can be communicated to the user and can be identified, for example, as a bottom misalignment. Solutions can include enlarging the deadbolt receiver 210, realigning the locking device 130 on the door 170, realigning the deadbolt assembly 132 in the locking device 130 (e.g., adjusting the location and/or angle at which the rods extend from the locking device 130), or any combination thereof.

FIG. 18C illustrates that multiple rods 202 can be inhibited or prevented from fully extending into the deadbolt receiver 210. For example, FIG. 18C illustrates a first resistive force 220a inhibiting or preventing a first rod 202a and a second resistive force 220b inhibiting or preventing a second rod 202b from partially or fully extending into the deadbolt receiver 210. The first rod spring 204a can be compressed to a compressed length 214 and the second rod spring 204b can be compressed to a compressed length 216. The compressed length 216 can be about 0.0625 inches to about 0.2500 inches, including every 0.0625 inch increment within this range (e.g., about 0.1250 inches). The lengths 214 and 216 can be the same or different from one another. For example, the first force 220a can be greater than the second force 220b such that the length 214 (e.g., 0.0625 inches) can be less than the length 216 (e.g., 0.1250 inches). The first rod 202a can be prevented from extending into the deadbolt receiver 210, the second rod 202b can partially extend into the deadbolt receiver 210, and the other rods 202 can fully extend into the deadbolt receiver 210 such that the second rod 202b and the other rods 202 (except the first rod 202a) lock the locking device 130 to the door 170. The misalignment in FIG. 18B can be communicated to the user and can be identified, for example, as a bottom misalignment. Solutions can include enlarging the deadbolt receiver 210, realigning the locking device 130 on the door 170, realigning the deadbolt assembly 132 in the locking device 130, or any combination thereof.

FIG. 18D illustrates a variation of a top misalignment.

FIG. 18E illustrates that the spring-loaded rods 202 can be used to determine whether or not the door is ajar. For example, the springs 204 can be in tension when the door 170 is ajar. The rods 202 can extend the springs 204 when the door 170 is ajar. For example, the springs can have a tension length 218 when the door 170 is ajar. The tension length 218 can be about 0.0625 to 1.000 inches greater than the spring neutral length 212, including every 0.0625 inches within this range (e.g., 0.1250 inches). The sensors 206 can be configured to measure the tension from the rods 202 and inform the user that the door 170 is ajar based at least partly on the detected tensile forces.

The rods 202 can be metal. The rods 202 can be straight or curved. The rods 202 can all of the same shape. One or more rods 202 can have a different shape from one or more other rods 202. The rods 202 can have the same or different sizes relative to one another. For example, middle rods 202 can be longer than perimeter rods 202. One or more of the rods 202 (e.g., all of the rods 202) can be tapered. For example, one or more of the rods can have the taper 137 or can have multiple tapers (e.g., tapers 137a and 137b). The rods 202 can have, for example, circular, elliptical, polygonal cross-sections, or any combination thereof. The rod cross-sections can be perpendicular to rod longitudinal axes.

FIG. 18F illustrates that the multi-rod deadbolt 121 can have 9 rods 202. FIG. 18F further illustrates that the rods 202 can form a square shape. FIG. 18F further illustrates that the rods 202 can have a circular

FIG. 18G illustrates that the corner rods 202 of the multi-rod deadbolt 121 of FIG. 18F can be tapered, for example, with the taper 137.

FIG. 18H illustrates that the rods 202 can form a diamond shape.

FIG. 18I illustrates that the multi-rod deadbolt 121 can have 25 rods 202. FIG. 18F further illustrates that the rods 202 can form a square shape.

FIG. 18J illustrates that the multi-rod deadbolt 121 can have 21 rods 202. FIG. 18F further illustrates that the rods 202 can form a cross shape.

FIG. 18K illustrates that the multi-rod deadbolt 121 can rods having multiple sizes, for example, a first size rod 202i and a second size rod 202ii larger than the first size rod 202i.

FIG. 18L illustrates that the multi-rod deadbolt 121 can rods having multiple sizes and shapes. For example, the first and second size rods 202i, 202ii can have a circular cross-section and a third size rod 202iii can have a rectangular cross-section.

Machine Learning

Data from each user can be monitored, collected, and stored. The data can be stored in a database, for example, in the cloud. The cloud and/or a backend system can analyze the data.

Data from multiple users can be analyzed to estimate the battery life of the locking device 130. To determine the battery life, locking device usage patterns can be collected and analyzed, including the frequency of motion activated events (e.g., deliveries, doorbell rings), the frequency of opening and closing the door, manual use of the lock, automatic use of the lock, the number of times the locking device 130 connects to a network (e.g., WiFi), the number of times the camera, microphone and speakers are activated and the duration of each activation, the number of times the door is locked and unlocked, or any combination thereof. Through the backend, the cloud can read and analyze this data. The data can be displayed on a dashboard for each user and/or for each type of door. Based on this data, machine learning can be used to estimate the battery life (e.g., percentage remaining, hours, days, weeks, months) and how much longer the battery will last (e.g., hours, days, weeks, months). For example, the dashboard can indicate the percentage of the battery that is remaining and/or the amount of time left until the battery will need to be recharged or replaced. For example, the application (e.g., via the dashboard) can inform users of the approximate number of days of battery life remaining (e.g., 30 days, 40 days).

Data from multiple users can be analyzed to determine when the door is misaligned. For example, lock motor performance can be collected and analyzed to determine door misalignment. The locking device 130 can have current and position sensors that can be used to inform users how much force is required to push the bolt out and pull the bolt in. Such sensors can also inform users whether the deadbolt 121 reaches the end position or not (e.g., the fully locked position). The current can spike when the deadbolt 121 (and/or one or more rods 202) is stuck in a misaligned position. The amount of current drawn from the battery can be recorded. Based on the number of times the position sensors are not reached and how much current is drawn from the battery during locking and unlocking, machine learning can be used to determine whether and to what extent a door is misaligned.

U.S. Provisional Application No. 62/564,852, filed Sep. 28, 2017; U.S. Provisional Application No. 62/578,295, filed Oct. 27, 2017; U.S. patent application Ser. No. 15/360,758, filed Nov. 23, 2016; U.S. patent application Ser. No. 14/736,126, filed Jun. 10, 2015; U.S. patent application Ser. No. 14/736,072, filed Jun. 10, 2015; U.S. patent application Ser. No. 14/641,069, filed Mar. 6, 2015; and U.S. patent application Ser. No. 14/641,047, filed Mar. 6, 2015 are all incorporated herein by reference in their entireties for all purposes.

The variations disclosed herein are offered by way of example only. The claims are not limited to the variations shown in the drawings, but instead can claim any feature disclosed or contemplated in the disclosure as a whole. Any elements described herein as singular can be pluralized (i.e., anything described as “one” can be more than one). Any elements described herein as plural can be singularized (i.e., anything described as more than one can be “one.”). Any species element of a genus element can have the characteristics or elements of any other species element of that genus. Some elements may be absent from individual figures for reasons of illustrative clarity. The above-described configurations, elements or complete assemblies and methods and their elements for carrying out the disclosure, and variations of aspects of the disclosure can be combined and modified with each other in any combination.

We claim:

1. A packageable assembly for an electronic device, comprising:
an electronic locking device; and
a packaging fixture,
wherein the packageable assembly comprises a first configuration and a second configuration, wherein the electronic locking device is assembled on the packaging fixture when the packageable assembly is in the first configuration, and wherein the electronic locking device is detached from the packaging fixture when the packageable assembly is in the second configuration.

2. A locking device packaging fixture system, for demonstrating a locking device, comprising:
a packaging fixture, wherein the locking device packaging fixture is configured to allow a user to operate a door management platform before the locking device is installed in a door.

3. The system of claim 2 wherein the door lock management platform is configured to send, via a wireless communication interface, a real-time stream of video acquired by the camera to a computing device of an administrator of a door management platform.

4. A locking device packaging fixture system, comprising:
a locking device;
a door management platform; and
a packaging fixture comprising a packaging block,
wherein the packaging fixture is of the same thickness as a standard outside door, and wherein the locking device is removably attached to the packaging block.

5. A method for utilizing a locking device packaging fixture, for testing a locking device, the locking device packaging fixture including a door management platform, the method comprising:
providing a real-time video stream and/or two-way real-time audio connection between the door management platform and the computing device to enable a first user and a second user to be able to communicate, and
locking or unlocking the door management platform in response to a message from the computing device based on the real-time video stream and/or the two-way real-time audio connection.

6. A method for removing a locking device from a packaging fixture and installing the locking device on a door, the steps comprising:
removing first alignment and connection elements of a deadbolt knob from second alignment and connection elements;
removing a deadbolt knob from the back face of a packaging fixture;
removing a lock front enclosure from a front face of the packaging fixture;
removing a deadbolt from a lateral face of the packaging fixture;
inserting a deadbolt into a cross-bore of the door;
screwing a face plate to a lateral face of the door;
sliding a deadbolt tailpiece through a tailpiece receiver; and
connecting the first alignment and connection elements of a deadbolt knob to second alignment and connection elements of a lock front enclosure.
